(19) United States
(12) Patent Application Publication
(10) Pub. No.: US 2010/0076952 A1
(43) Pub. Date: Mar. 25, 2010

(54) SELF CONTAINED MULTI-DIMENSIONAL TRAFFIC DATA REPORTING AND ANALYSIS IN A LARGE SCALE SEARCH HOSTING SYSTEM

(76) Inventors: Xuejun Wang, San Jose, CA (US); Ryan Edmund Sue, Fremont, CA (US); Lucas Marshall, Emersville, CA (US); Kaushal Kurapati, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/242,272

(22) Filed: Sep. 30, 2008

Related U.S. Application Data
(63) Continuation-in-part of application No. 12/205,107, filed on Sep. 5, 2008.

(51) Int. Cl. G06F 7/10; G06F 17/30

(52) U.S. Cl. 707/706; 707/E17.014

(57) ABSTRACT

A method is provided for reporting and analyzing user search behaviors in a large scale heterogeneous search engine platform. Content repository managers want to understand how users search for content in their repository including what categories and attributes users are interested in, how users were referred to the site, and which searchable items were viewed. The method provides a low-cost alternative to OLAP and data warehouse solutions and exploits the scalability and user interface of a search engine. Furthermore, the taxonomy of the content repository needed for analysis is already known to the search engine, and need not be exported or represented in a different format required by another tool. Data analysis can be conducted interactively and in real-time.

### PRIORITY CLAIM AND CROSS REFERENCE TO RELATED APPLICATIONS

The present claims priority as a continuation-in-part of U.S. patent application Ser. No. 12/205,107 filed on Sep. 5, 2008, entitled “Performing Large Scale Structured Search Allowing Partial Schema Changes without System Downtime,” the entire contents of which are incorporated herein by reference.

This application is also related to U.S. patent application Ser. No. 12/______ (Docket No. 50269-1062) filed on ______ entitled “Performing Search Query Dimensional Analysis on Heterogeneous Structured Data Based on Relative Density”, the entire contents of which are incorporated herein by reference.

### FIELD OF THE INVENTION

The present invention relates to search engines, and in particular, to reporting and analyzing user search behavior when interacting with a large scale search hosting system supporting multiple heterogeneous vertical search repositories.

### BACKGROUND

A search domain is a self-contained set of information pages, usually specific to a subject or function. Frequently, web sites that provide searching functionality are directed to a specific search domain. For examples, a web site for shopping may allow searching in the “product” domain, a web site for downloading music may allow searching in the “music” domain, a web site focused on medical information may allow users to look up medical information, and a financial web site may allow users to search for products or services relating to managing finances. Typically, at each of these sites, the information pages, together with structure and indexing information, are stored in a data repository.

Search engines may be used to index a large amount of information. Web sites that include search engines typically provide an interface that can be used to search the indexed information by entering certain words or phrases (keywords) to be queried. The information indexed by a search engine may be referred to as information pages, content, or documents. These terms are often used interchangeably.

A searchable item is a logical representation of an information page or piece of content that is maintained within a search engine platform. Search engines help users to locate searchable items. Sometimes a searchable item represents an electronic document, such as a white paper, or content, such as a video that can be viewed by streaming it over a network connection or downloaded to a computer system for local viewing. Other times, the searchable item is a description and representation of something in the real, physical world, such as a person, or a product for sale. Searchable items can be descriptions of electronic or physical items.

Search engines may analyze the searchable items within a repository, extracting categorization information and constructing indexes that are used to find relevant data when a search is requested. Using a search engine, a user can enter one or more search query terms and obtain a list of search results that contain or are associated with subject matter that matches those search query terms. When a user performs a search, the set of pages found during the search and presented to the user along with other search and navigation hints are called the “search results.” Each page listed in the search results is called a “hit.” When a user submits a search query or selects a content page for viewing, that event is called a “click.” When choosing a next category or attribute to explore using guided navigation or choosing a content page to view usually, though not always, is specified by clicking a mouse button.

One example of a search engine is a vertical domain search engine. A vertical domain search engine provides searching over a specific search domain. Examples of vertical domain databases include databases for searching for legal or medical information. Within each of these examples, the content searched for has a common subject (law or medicine, respectively) and is assigned categories and attributes relevant to the subject matter by domain experts who manage the content. For example, categories supported by a law search engine might include State or Federal Case Law, State or Federal Statutes, Treatises, Legal Dictionaries, Form books, etc. with attributes such as publication date, legal topic, history, etc. A medical search engine might have categories of Symptoms, Diagnostic procedures, Treatments, and Drugs. Attributes might include parts of the body affected and have potential values such as respiratory, circulatory, nervous system, etc. The repository for both vertical domains is highly structured within each system, but the structure for each domain is different from the structure of domains pertaining to different subject matter.

A problem faced by companies that own and operate vertical domain search engines is that, in addition to having to manage the structure of the repository, the companies must also manage the search engine platform including database management. Domain experts are not necessarily experts in IT management which can be very complex. To avoid the need for each company to maintain its own vertical search engine, multiple companies may try to combine their search engines. One way to achieve this is for a company to outsource the operation of their search engine to a third party provider (a “search host”).

When a company outsources their search engine operation to a search host, their content repository may share a search engine platform with the repositories of other customers of the same search host. Further, the search host may provide users an interface that allows users to submit a single search request to search across the multiple vertical domains hosted by the search host. For example, the search engine of a search host that hosts both a legal search engine and a medical search engine might provide a user searching for information on medical malpractice with content from both medical and legal repositories with one search request.

Typically, the owners of a data repository will want to understand the searching behavior of the users, including (a) how users search, (b) what categories and attributes users are interested in, (c) how users were referred to the site, and (d) which searchable items were viewed. There can be a number of reasons why this information is useful. Such usage data can help to sell advertising. In addition, such usage data may indicate that optimizations should be made in the repository hierarchy. As another example, such usage data may indicate that the owner should change the level of inventory of products based on the amount of interest in the categories to which the products belong. When data repository owners have their search engine services hosted by a search host, the data repository owners will look to the search host for information about how their search repositories are being used.

Thus, a search host should have the ability to produce highly custom reports to its customers regarding user search behavior. However, a shared search engine hosting platform includes repositories with very different structures. Generating custom reports for each different customer is difficult because the structure of their data is different from each other. Not only is the structure of the data to be analyzed different, but the kind of reports each customer requires is likely to be different too. Custom report generation requires significant effort that cannot be shared from one customer to the next.

There are two main approaches to obtaining data analysis information. First, online analytic processing (OLAP) allows data managers to create their own reports using a query language or specification. To use OLAP, the structure of the content must be loaded into the tool. To obtain usage information, a query is submitted to the system, and a reply comes back. In order to use OLAP, a data manager must be able to express the desired information in the form of a query.

Second, data warehousing solutions are available, allowing content managers to mine data from a database. Data warehouse solutions are very expensive and are usually run in batch mode. There is little to no interaction in formulating queries. Furthermore, the data is not explored in real time. With the hundreds of thousands of different searches that users can perform, it would not be possible to write code to retrieve information about all of the different searches that user's have performed. The data warehouse platform itself is also not scalable (cannot support large numbers of concurrent queries).

There's a need to provide a low cost search engine hosting solution that can provide a uniform way of reporting usage data to its customers through an interactive and intuitive user interface with the ability to view the data in near real time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is an example screen shot of the navigation user interface highlighting the selection of top level categories for a shopping example.

FIG. 2 is an example screen shot showing the expansion of a category into subcategories and the number of searchable items contained within each category.

FIG. 3 is an example screen shot showing the attribute name/value pairs and the effect their selection has on the results.

FIG. 4 is a flow diagram showing the steps of enabling a search engine environment to find searchable items from a repository.

FIG. 5 is a diagram showing a logical graph structure where the nodes of the graph represent categories specific to a domain.

FIG. 6 is a diagram showing a logical view of node in the hierarchy.

FIG. 7 shows an example of a customer interface to a usage reporting page

FIG. 8 shows an example of a report used to analyze usage data.

FIG. 9 is a flow diagram showing the steps to creating searchable items in the reporting repository hierarchy.

FIG. 10 shows an example of the relationship between a content repository and its corresponding reporting hierarchy.

FIG. 11 shows, for an example query, the content of an example searchable item that satisfies the query in the content repository, and the content of the searchable item in the reporting hierarchy created as a result of the query.

FIG. 12 is a block diagram that illustrates a computer system.

### DETAILED DESCRIPTION

The approach presented herein may be implemented in conjunction with the system described in U.S. patent application Ser. No. 12/205,107 entitled “Performing Large Scale Structured Search Allowing Partial Schema Changes Without System Downtime.” That system includes a flexible data repository hierarchy. In addition, in that system, a search engine provides an intuitive, interactive user interface for searching and navigating data contained in the repository hierarchy. The system may be optimized to handle millions of concurrent queries and hundreds of thousands of different queries.

The flexible hierarchical structure reflects the taxonomy of the searchable content, and the search engine already interprets the structure of that taxonomy. According to one embodiment, the same search engine platform that is used to provide cross-repository searches is also used to provide customized usage data to the owners of those repositories. Consequently, reporting the search usage data does not require separately codifying instructions for generating customized reports. In addition, because the same platform that is used for searching is used for reporting usage data, there is also no need to import the taxonomy of the content repository into a separate OLAP tool before the analysis can take place. Furthermore, in one embodiment, the click data that represents user interaction with the search interface is both generated by, and analyzed by, the same search engine, allowing analysis to be done interactively and in real-time.

Leveraging the search engine as the reporting tool provides the same user interface to content managers for viewing their usage data as to end users for searching content in the repository. The same structure used to store, search, and retrieve data in a content repository is used to store, search, and navigate usage data.

In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Various aspects of the invention are described hereinafter in the following sections.

### A Shopping Example

The example provided in this section is intended to make the concepts described herein more concrete, and is only one of many possible embodiments.

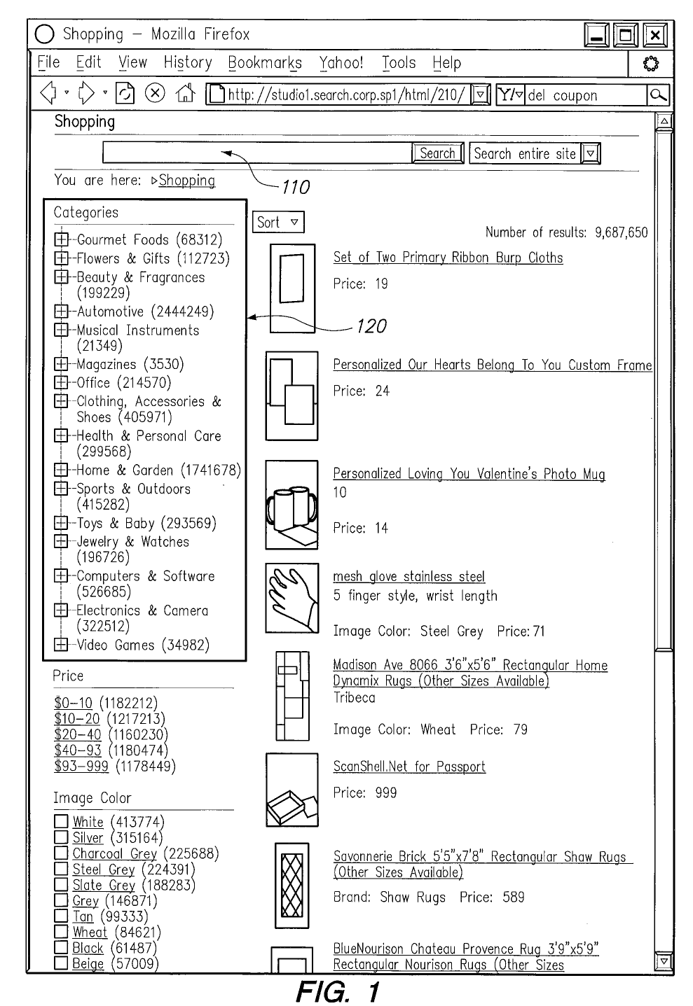

Consider a user visiting an online shopping web site. FIG. 1 shows such an example web page. At the top of the page, there is a place for users to enter search criteria using free form query terms, i.e. terms of their own choosing (110). A query button is clicked to initiate a query that is based upon the entered search criteria.

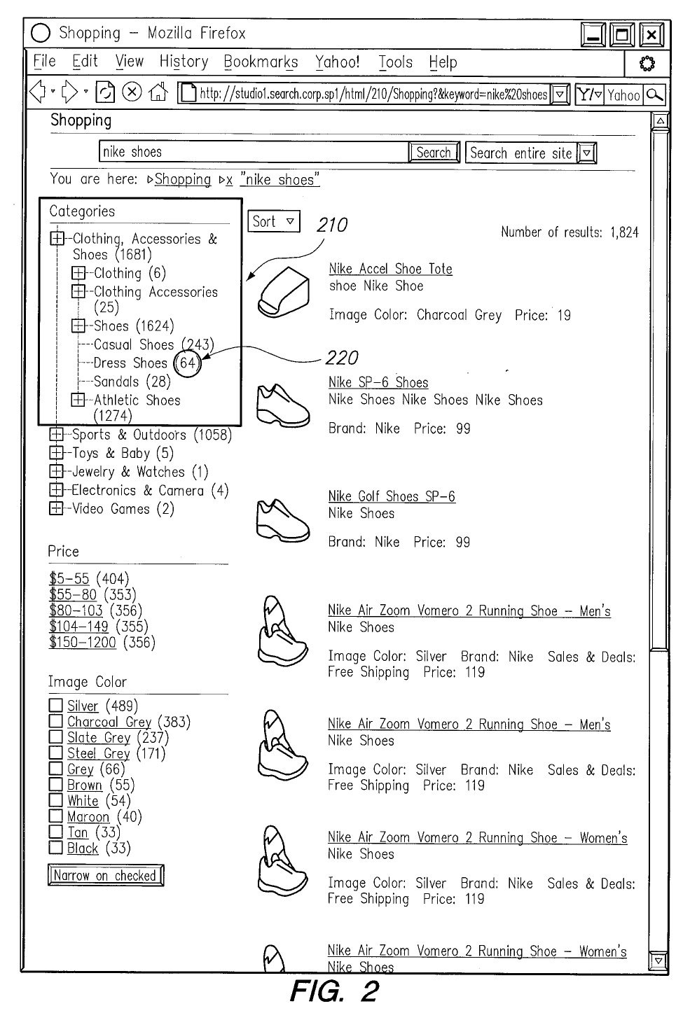

Specifying search terms is one way of specifying search criteria. Another way of specifying search criteria is by navigating a category hierarchy. Referring again to FIG. 1, in the upper part of the left margin is the shopping category hierarchy (120). By clicking on the plus sign to the left of a category name, the category is expanded and the category's subcategories are then displayed on the page. For example, if a user clicks on “Clothing, Accessories & Shoes,” separate subcategories of “Clothing,” “Clothing Accessories,” and “Shoes” are shown (FIG. 2, 210). “Shoes” can be further expanded into “Casual Shoes,” “Dress Shoes,” “Sandals,” and “Athletic Shoes.”

Specifying search criteria using search terms may be combined with specifying search criteria using navigation. For example, a user may specify search terms, and then navigate through the category hierarchy. As the user navigates, the user is presented with only those searchable items that (a) are associated with the category to which the user has navigated, and (b) that match the specified search terms.

Referring again to FIG. 1, to the right of each category name is a number in parentheses. This number indicates how many searchable items are contained within (belong to) that category and match the specified search criteria. As shall be described in greater detail below, that search criteria may be represented by attribute name/value pairs that reflect desired attributes that have been selected by a user. In the illustrated example, the “(64)” in the “Dress Shoes” category (220) indicates that there are 64 dress shoe products for sale through this web site. No attributes have been selected, so the total count of all dress shoe products is displayed.

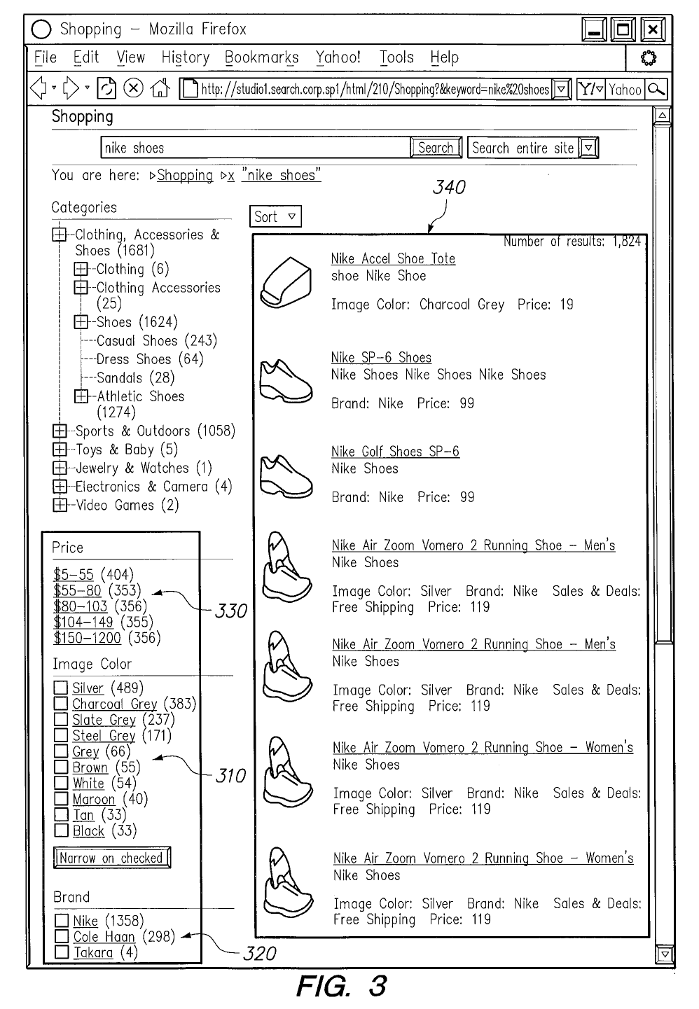

In FIG. 3, below the category hierarchy in the left margin is a set of attribute name/value pairs. Attribute names in this example are “Price,” “Image Color,” and “Brand” (310). Below each attribute name are a set of checkboxes, and next to each checkbox is an attribute value. One attribute value for “Brand” is value “Nike” (320) and one attribute value for “Price” is the value range $55-$80 (330). By checking a checkbox next to an attribute value, a user adds the attribute value as part of the search criteria. As a result, the search engine will filter the searchable items that will be displayed as search results in the main screen (340) to include only those that contain the matching attribute name/value pairs.

For example, if the user has navigated to the category Shoes, then clicks the checkbox under Brand next to Nike, only searchable items that are Nike Shoes will appear in the results window. As explained above, the number next to a category name in parentheses would reflect the number of searchable items that match the selected attributes. For example, in FIG. 2, if under the attribute “Color” the box labeled “Black” had been selected, only the number of Black Dress Shoes would be presented in parentheses.

### Representing Vertical Search Repositories in a Node Hierarchy

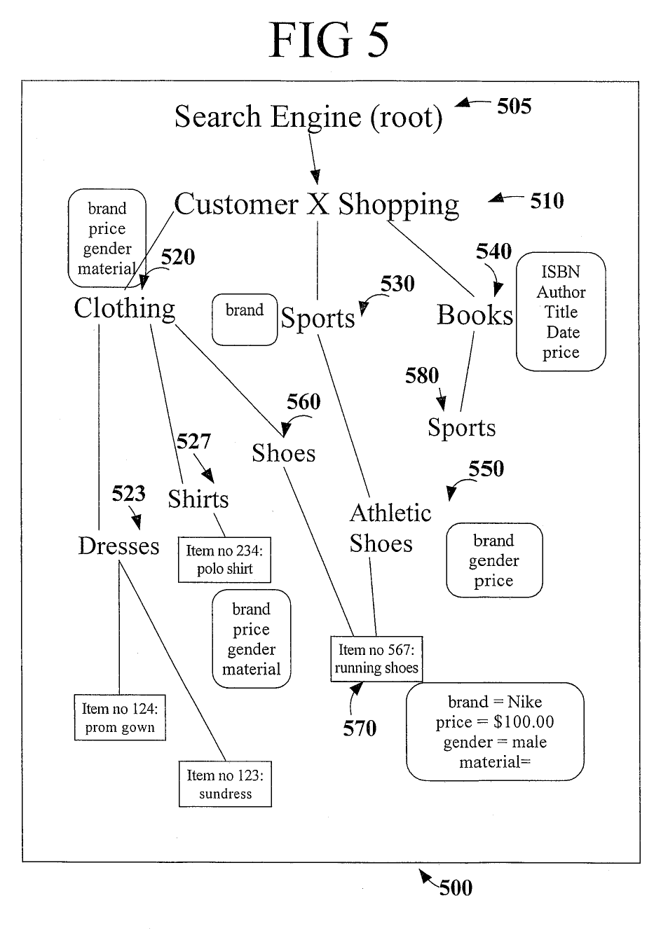

In one embodiment, a search engine platform is used for searching over multiple vertical domain repositories whose content is heterogeneous in structure and semantics. In one embodiment, the vertical search repositories are represented as subgraphs within a node hierarchy. According to this embodiment, building such a heterogeneous search engine involves constructing a hierarchy that is a directed graph of nodes similar to a tree. The nodes of the hierarchy represent elements of the logical search repositories that are hosted by the platform. One embodiment of such a hierarchy is illustrated in FIG. 5.

Referring to FIG. 5, the root of the hierarchy (505) represents the global search engine, and has no parents. Multiple repositories can be represented in the overall search space, each repository represented by a subgraph of the overall hierarchical structure. In one embodiment, each node other than the root represents a category, and is therefore referred to herein as a category node. Category nodes within a vertical search space represent classifications of the search items. For example, a category node of clothing might have children category nodes including dresses, pants, skirts, etc. Category nodes towards the top of a tree are more general than their children category nodes which provide refinement.

The terminology used to describe the relationships of nodes is the same as for general hierarchies. If node 1 is a descendent of node 2, then there is a path following links between the root and node 1 that contains node 2. If node 1 is a descendant of node 2, then node 1 is said to descend from node 2. Nodes may be the root of a subgraph which includes the node and all of its descendents.

Unlike a tree, nodes in the directed graph may have more than one parent node. Thus, one category node may descend from other category nodes that have no direct relationship with each other. For example, a category that represents athletic shoes may descend from both a “Shoe” category and a “Sports” category.

### Attributes

According to one embodiment, each category has associated attributes that are relevant to that category. For example, attributes relevant to clothing might include, for example, size, gender, price, and color. The attributes of a category node are inherited by their children nodes. Thus, in the example, because a shirt is a kind of clothing, all the attributes of the clothing category (e.g. size, gender, price, and color) apply to the shirt category. All searchable items have all the attributes of the category node to which the searchable items are attached (which, as explained above, includes all of the attributes of ancestor nodes of that category node). An attribute, together with the value of the attribute, is called an attribute/value pair. Thus, any given searchable item may be associated with multiple attribute/value pairs. For example, a particular shirt may be associated with the attribute/value pairs: (size, 14), (gender, male), (price, $20), (color, red), etc.

### Searchable Item Records

According to one embodiment, each searchable item of a vertical search repository is represented by a searchable item record. The searchable item record for a particular searchable item is linked to one category node to which the particular searchable item belongs. In one embodiment, linking a searchable item to a category is achieved by storing a link in the node to the searchable item record, and optionally the category to which a searchable item is linked is recorded in the searchable item record. In another embodiment, the searchable item record contains a link to the category node to which it is linked. For example, the searchable item record for a particular jacket may be linked to the node that represents the “jackets and coats” category. Optionally, the searchable item record may contain a link to, or other indication of, all of the categories that apply to the item. In other words, the searchable item record may be tagged with all of the ancestral categories of the node to which it belongs.

All searchable item records of the subgraph linked to the dresses category node represent searchable items related to dresses in some way, depending on the vertical domain subject matter. For a shopping domain, searchable items belonging to the category shirts probably represent a piece of clothing for sale. Within a theatrical domain, searchable items belonging to category shirts might represent information on costume design.

In addition, searchable items contain a set of attribute name/value pairs. The type of a searchable item is defined by the set of attributes for which attribute values may be specified within the searchable item.

### Obtaining Content for a Vertical Domain Repository

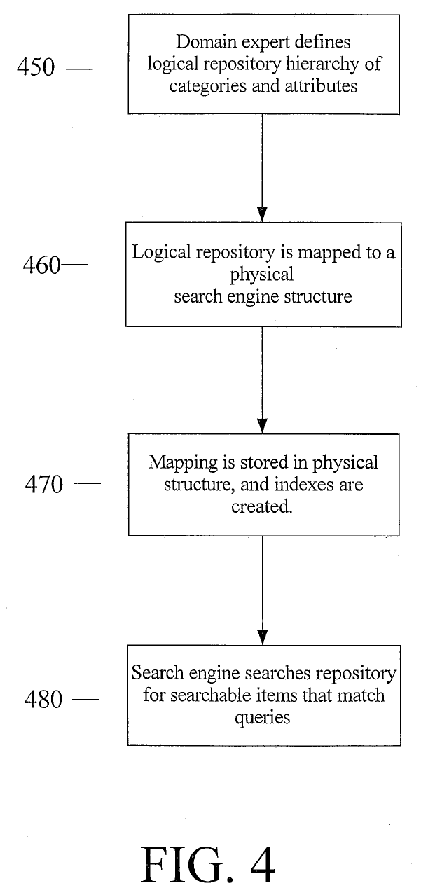

FIG. 4 shows the process for getting content from a vertical domain to be searchable on a shared search engine platform. In the embodiment illustrated in FIG. 4, domain experts define the logical hierarchy of categories and attributes that represent their repository and how the repository can be searched (Step 450). A domain expert can interact with an Integrated Development Environment (IDE) that provides a graphical user interface (GUI) or alternatively, a domain expert may upload a definition of the hierarchy constructed in some other way. The domain expert defines a logical hierarchy comprising of categories, logical attributes, and the relationships among them. For example, transportation->cars->convertibles->classic cars might be one category hierarchy that a domain expert would choose. Hobbies->classic cars->convertibles might be another. The way in which the category hierarchy is defined determines how users can browse through the content. Logical attributes are a type of information associated with a category that is common across a subset of a category hierarchy. For example, model year might be an attribute of cars, convertibles, and classic cars, but not of transportation or hobbies.

Once the domain expert is finished defining the category hierarchy, the hosting service is responsible for translating the logical description of the content structure into the physical structure of the shared search engine hosting platform that can be accessed by the search engine (Steps 460, 470). A mapping from the logical description to the physical storage is computed (Step 460), then the mapping and the computed indexes are stored in the physical structure (Step 470). Once loaded into the physical hosting platform, a user can interact with the search engine to find desired content (Step 480).

### Defining the Hierarchy

FIG. 5 shows an example of the logical representation of a customer's searchable content 500. In this example, the customer's searchable content is products for sale. The root of the hierarchy is the virtual search engine node 505. The root node is virtual because this node is not indexed. The root is a parent of all of the top level subgraphs, each of which can represent a distinct repository. There are three rules imposed on the logical hierarchical structure. First, there no cycles allowed in the graph. Thus, a node cannot both descend from, and be an ancestor of, the same other node.

Second, there is a single configurable limit on the number of attributes that are associated with any given node, and that number must not exceed the number of physical attributes that are indexed by the platform. For example, assume that the platform indexes 20 physical attributes. If a particular category node is associated with 15 attributes, then category nodes that descend from that particular category node may define, at most, five additional attributes. The limit on the total number of attributes that can be associated with any given node ensures that for every node, there is a mapping for each logical attribute of the node to a different physical attribute of the platform.

In the example illustrated in FIG. 5, Customer X Shopping 510 is the top-level node of the subgraph representing a content repository. Directly under the top-level node 510, are the top-level categories, Clothing 520, Sports 530, and Books 540.

The rounded rectangles next to some of the nodes shown in FIG. 5 contain example attributes associated with the node. The attributes associated with Clothing 520 include brand, price, gender, and material. All nodes in the subgraph rooted at Clothing 520 will have at least this set of attributes, and therefore, all searchable items of Clothing will contain at least these attributes. Notice, however, that the category Sports 530 only has one attribute, brand. Brand means the same thing with respect to sports as it means to with respect to clothing. Consequently, the brand attribute of Clothing is “semantically identical” to the brand attribute of Sports. Category Books 540, on the other hand, has no attributes in common with Sports 530, either in name or in meaning. Thus, all of its attributes are “semantically different” or distinct from the attributes of Sports 530.

Athletic Shoes 550 is a child node of both Shoes 560 and Sports 530, and must inherit all the attributes of both parents. Athletic Shoes 550 inherits the brand, price, gender, and material attributes from Shoes 560 (which inherited these attributes from Clothing 520). Athletic Shoes 550 also inherits the store attribute from Sports 530, and also has a new attribute sport assigned to its own node that all of its children will inherit.

The searchable item records of the hierarchy are the searchable items, which in this example are the product descriptions. The searchable item representing Item no 567 (570) is a particular kind of running shoe for sale that is linked to the Athletic Shoes 550 category. Thus, the searchable item 570 may specify values for each of the attributes of Athletic Shoes 550. Searchable item 570 has attribute values specified for most of the attributes. In this example, Item no. 567 (570) is a men's Nike brand running shoe that sells for $100 at the We Are Sports store.

### Rule Inheritance

In addition to attribute inheritance, the node hierarchy may also provide rule inheritance. A set of rules is stored in association with each category. The rules that are associated with a given category determine the behavior of the search engine with respect to that category. In one embodiment, the rules represent instructions on how to influence the relevancy of search results. Rules may be used to control several aspects of the search engine, such as data processing and results presentation. A node may inherit the rules of its parent nodes, as well as have rules directly assigned to it.

For example, the category Shoes may be associated with the rule to display the top 3 attribute name/value pairs when displaying the results of a search for providing suggestions to the user of where to search next. The category Athletic Shoes may inherit the same behavior of its parent or override the rule to include 5 attribute name/value pairs in its display of output results.

### Logical Structure of a Node

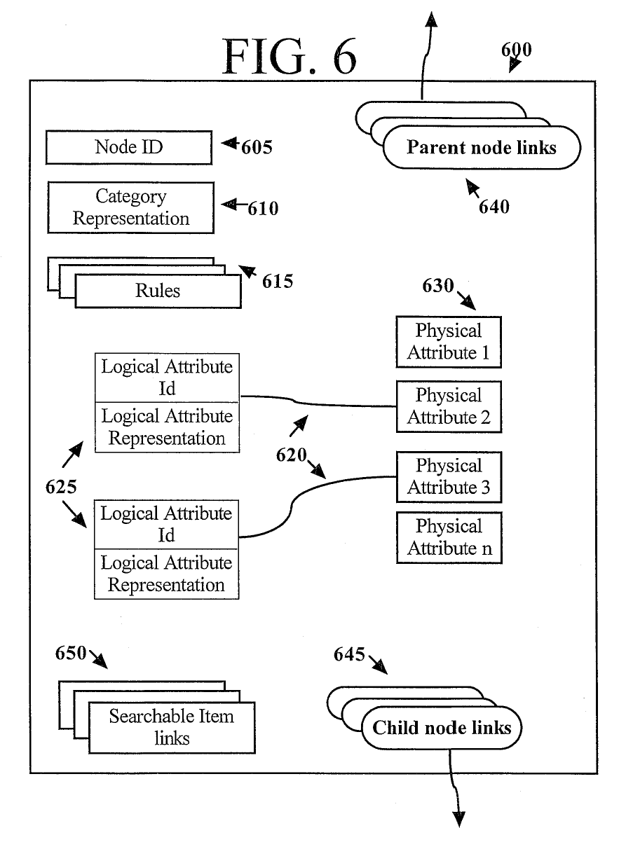

FIG. 6 shows a logical view of one embodiment of a category node 600. Node 600 contains Parent Links 640 and Children Links 645 that together represent the node's position in the hierarchy. The Category Id 605, also called a “node id” provides unique identification of the node in the hierarchy. A node also contains links to the Searchable Items 650 that link the node to the set of searchable items belonging directly to the category. A searchable item belongs to a category if the searchable item record is linked to the category node.

The Category Representation 610 is a way of identifying the category to a user. Category Representation 610 might be an icon or text, for example. In FIG. 2, the textual name “Athletic Shoes” is the category representation of node 600. Two different category nodes (different id's) could have the same Category Representation 610, but the categories would be considered different categories. For example, in FIG. 2, Books 240 has a child category node Sports 280 representing books about sports. Nodes 230 and 280 both have the same category representation: the textual name “Sports”, but 230 and 280 are different nodes and thus are different categories.

A node has a set of rules 615 that define category policy. Some example rules are: the sorting method to be used for the values of an attribute, how many and which attributes should be listed in the navigation panel before a “see more” link is shown to see the rest, and how many search results (aka searchable items) should be displayed per page in response to a query.

A node has a set of Logical Attribute Id's 625 that are relevant to the category of the node. Preferably, each logical attribute id in the system has a distinct semantic meaning. A logical attribute id has associated with it a representation for the user, Logical Attribute Representation. Even if different logical attribute id's were to have the same user representation, the logical attributes would be considered semantically different from each other. Conversely, different nodes that have the same associated attribute id's may use a different user representation for the same attribute id. For example, “price” may be the user representation for a logical attribute associated with one category, and “cost” may be the user representation for that same logical attribute in a different category. A name is the most common kind of user representation for an attribute but not the only kind. The term “attribute name/value pair” is used throughout to mean a user representation of a logical attribute together with the attribute's associated value and is not strictly limited to the use of a name as a user representation of an attribute.

Preferably, each of the Logical Attribute Id's 625 has a mapping 620 to single Physical Attribute 630. For example, assume that (1) category X has an attribute A, and (2) category Y has an attribute B that is semantically identical to attribute A of category X. Under these conditions, attributes A and B would have the same logical attribute id. Because attributes A and B have the same logical attribute id, both attributes A and B should be mapped to the same physical attribute.

### A Reporting Example

The owners of search repositories that are being hosted on a common search platform often desire statistics about how their search repositories are being used. Such statistics are referred to herein as “usage data”. Techniques are described hereafter for providing usage data information to search repository owners. In one embodiment, the techniques involve using the same search platform to both (a) allow users to search the repositories, and (b) allow repository owners to obtain the usage data.

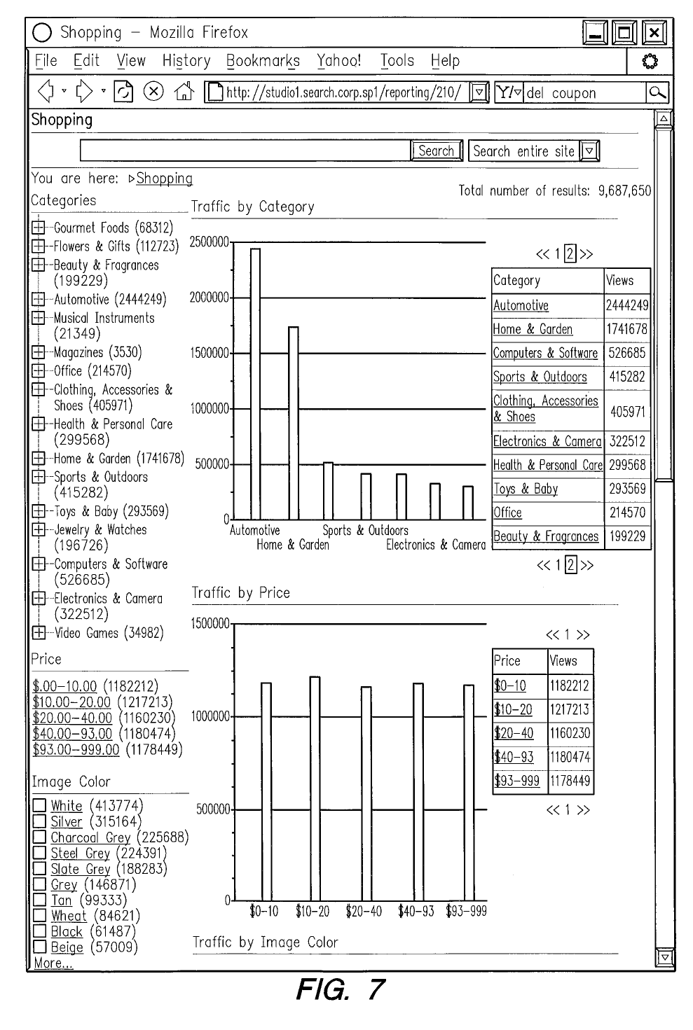

One embodiment of a multidimensional traffic reporting user interface shall be described hereafter with reference to FIG. 7. Referring to FIG. 7, it shows an example top-level reporting page for one customer of the search host that sells products through the hosted online shopping site. Notice that the look and feel of the user interface is the same for the reporting screen as it is for the search/navigation screen shown in FIGS. 1 and 2. However, the interpretation of the information on the screen is somewhat different.

Specifically, in the illustrated embodiment, the category names in the upper left margin include only those categories that belong to the repository of the particular repository owner that is using the reporting interface, and not the categories of all repositories that are hosted in the shared platform.

The number in parentheses next to each category name is the number of times users navigated to or searched for items in that category. For example, users visited or navigated to find searchable items in the “Electronics & Cameras” category 322512 times. The main results area shows the usage data graphed and tabulated based on category and attribute values. Navigating the category hierarchy drills down through the usage data to view usage of one of the subcategories. Similarly, selecting attribute value checkboxes allows the user of the reporting interface to view the number of times users searched for or filtered results using those attribute values. For example, Beige products were sought 57,009 times.

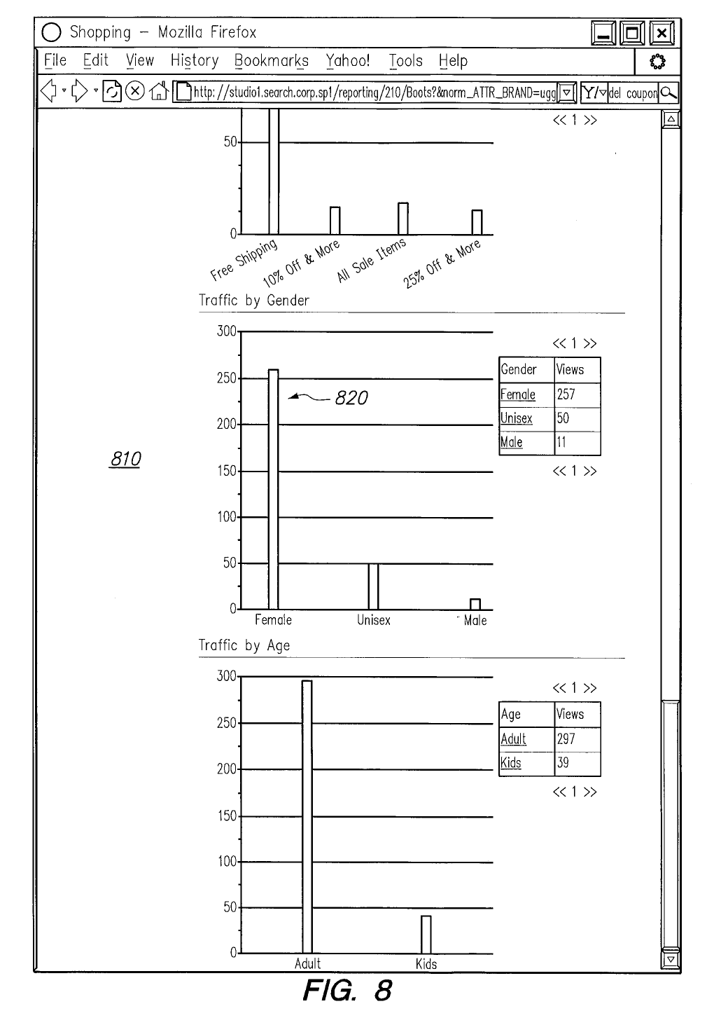

FIG. 8 shows an example of using the reporting information to analyze usage data. In this example, the customer wants to know which users are interested in Ugg boots. The customer navigated to the boots category (Shopping->Clothing, Accessories&Shoes->Shoes->Boots) and then selected the brand attribute value “Ugg.” In the results portion of the page, a graph is presented with usage data for each of the attributes associated with the category Boots. One of the attributes, Gender (810), shows that there is far more interest in Women's boots (820) than in Men's boots or unisex boots. Notice that “Boots” has no subcategories. It if had subcategories, there would have been an additional graph in the results area showing the usage by subcategory.

One of the benefits of this approach to reporting multidimensional traffic data is not only the uniformity between the reporting and searching user interfaces and the resulting simplicity in the user interface for the customers of the search host, but there is also a benefit to the search host: it is easy and inexpensive to provide a reporting interface that utilizes all the same user interface components that already exist to render the searching user interface.

### Reporting Repository

According to one embodiment, for each distinct content repository hosted within a shared search engine platform, a parallel reporting repository is constructed. The reporting repository hierarchy has the identical set of category nodes as its corresponding content repository. When a user expresses an interest in searchable items contained within a category and/or having an attribute value, that interest is recorded by adding a new searchable item record into the reporting subgraph contained within the corresponding category node and placing into that searchable item record the corresponding attribute values.

A searchable item is added into the reporting repository in a series of steps described in detail below. Users may express an interest in content in a variety of ways, and the techniques described herein are not limited to any particular way in which users express an interest in content. As an example of how users may express an interest in an item, a user may use guided navigation to select a category within the hierarchy and select a set of attribute values to use as filters on the result set.

As another example of how users may express an interest in an item, a user may click on a link that is already displayed in the search results area of a previous search. Regardless of how users express interest in content, click data is added to a log, and the user can continue searching or navigating asynchronously with respect to analysis of the logged data. Information is extracted from the logged click data to create a new searchable item record in the reporting hierarchy. The data in the log determines the contents of each such searchable item record and the location where it should be placed in the reporting hierarchy.

### Collecting and Adding Usage Data to Reporting Repository

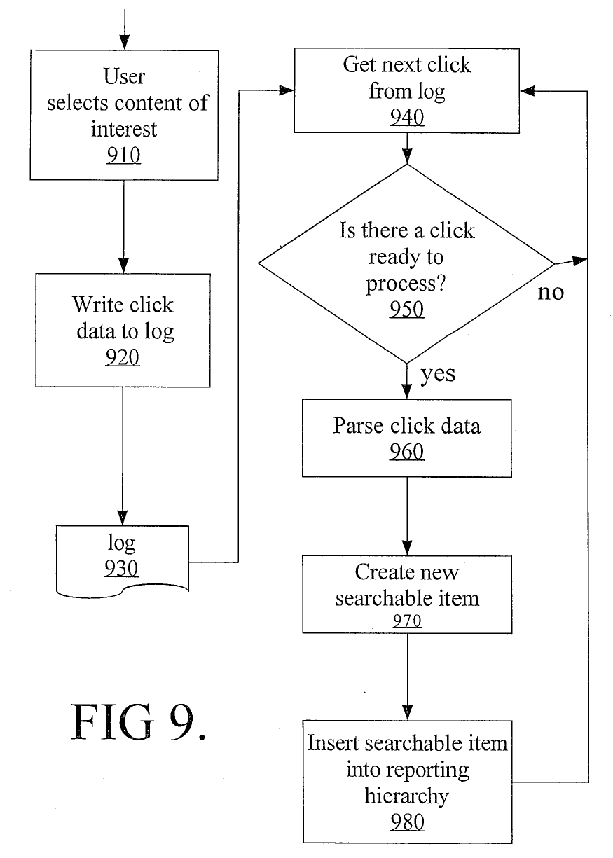

FIG. 9 shows the process for turning a click that occurs in the searching hierarchy into a searchable item in the reporting hierarchy. Searchable items that are added to the reporting hierarchy in response to actions that indicate user interest in searchable items in the content repository are referred to herein as “usage items”. Thus, a searchable item in the content repository may represent a particular athletic shoe, while a usage item in the reporting hierarchy may indicate that a user has performed some action to demonstrate an interest in that particular athletic shoe.

When a user navigates to a category in the content repository and selects a set of attribute values to filter the search results, a resulting usage item record is placed into the reporting hierarchy. The usage item record is linked to the corresponding category node in the reporting hierarchy, and the selected attribute name/value filters are placed within the new usage item record. Similarly, when a user clicks on a link presented in the results from a previous search, the category to which the clicked searchable item is linked identifies the corresponding category in the reporting hierarchy to which the new usage item record is added. All of the attribute name/value pairs in the content searchable item are copied into the usage item record.

In one embodiment, only the click data resulting from guided navigation is written to a log file for later analysis. In another embodiment, only the click data resulting from clicking on a searchable item displayed in the results area from a previous search are written to a log file for later analysis. In another embodiment, click data from both clicking on a link in the search results area and navigating is written to the log file.

In one embodiment, the log is stored in a file in the file system. A log reader (940) reads the log (930), and if there is unprocessed click data in the log (Step 950), the click data is parsed by a parsing module (Step 960). The parsed information is placed into a usage item record (970) and placed in a reporting repository (Step 980). For example, if a user navigates to Shopping->Clothing,Accessories&Shoes->Shoes->Boots with no attributes selected, a new usage item will be created in the corresponding reporting hierarchy at Clothing,Accessories&Shoes->Shoes->Boots with no attribute values filled in. If the user then clicks on the Ugg value of the attribute Brand, then a new usage item will be created within the same Boots node of the reporting hierarchy, but this new searchable item will have an attribute name/value pair of Brand=Ugg. Similarly, if the user had clicked on a link for a particular pair of Ugg boots for sale, a new usage item record would be added into the reporting repository linked to the Boots category node with the attribute name Brand and value Ugg.

According to one embodiment, information that is extracted from each query and placed into searchable items in the reporting hierarchy includes, but is not limited to:
a timestamp of when the click associated with the query occurred,
identification of the node in hierarchy providing context for the query,
the region of the page in which the click occurred,
the identity of the user that performed the click, and
the name of a referring site
   The referring site is relevant when the search engine is web based, and the search engine was reached through a different web site. In addition, the click data in each log entry contains the set of attribute name/value pairs that searchable items must contain in order to satisfy the query. Reading the log, creating new usage items from the click data, and adding the usage items to a reporting hierarchy can be done in near real time.

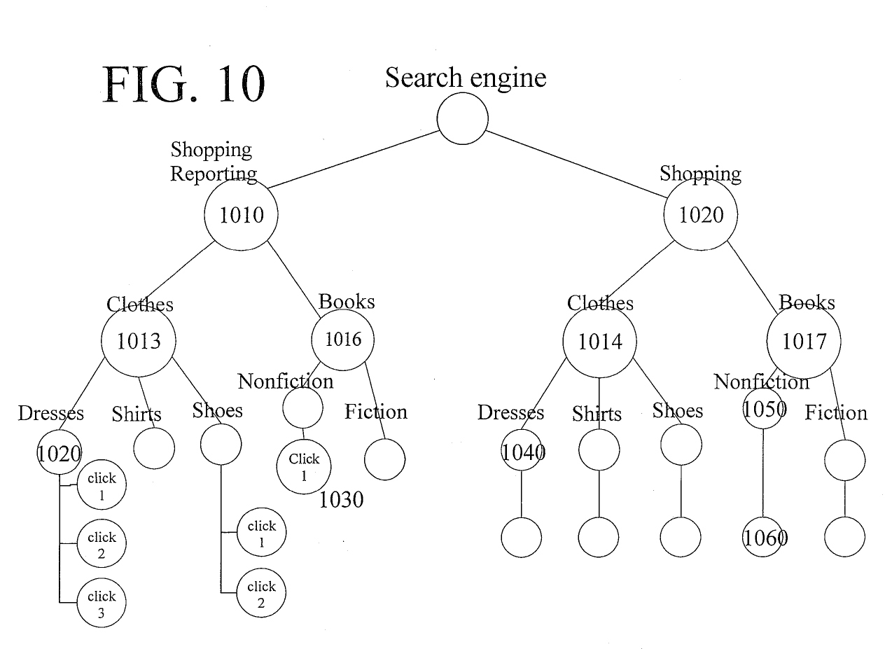

For example, FIG. 10 shows two corresponding hierarchies: a shopping vertical domain hierarchy 1020 on the right and the corresponding shopping reporting domain 1010 on the left. For each node in the content domain there is a corresponding node in the reporting hierarchy. Circles without category name labels, such as 1060, represent searchable items associated with the node to which the searchable items are attached. If a user navigates to the Clothes node 1014 and clicks on “Dresses,” a usage event is generated associated with node 1040. The usage event is stored in a log.

Once read from the log, the usage event results in creation of a usage item. The usage item for the usage event is added to the reporting tree at Dresses node 1020, because node 1020 is the node in the reporting repository corresponding to node 1040 in the content repository. Notice that the searchable item in the content hierarchy associated with 1040 was not clicked in this example. Notice also that there are three usage items associated with 1020, indicating that 1040 has been clicked a total of three times (presumably twice by users outside of this example). Thus, the searchable items in the content repository do not necessarily have a one-to-one correspondence to the usage items in the reporting repository.

Another example involves the books subgraph of FIG. 10. A user navigates to the Nonfiction node 1050 and the searchable item 1060 is displayed in the search results area because searchable item 1060 satisfies the query. The corresponding usage item is added as 1030 in the reporting tree.

According to one embodiment, there are two differences between the content hierarchy and its corresponding reporting hierarchy. First, the top level reporting repository node defines attributes specific to the reporting data, such as timestamp, referrer id, and the other information extracted from every usage event. Thus, these are attributes of every usage item in the reporting hierarchy, while they may not be attributes of the searchable items in the content repository. All nodes in the reporting hierarchy inherit these attributes.

Second, the usage items in the reporting hierarchy represent clicks, not content. Whereas the content of a searchable item in a content repository is interesting, the count of usage items, and their attribute name/value pairs, is interesting to customers interacting with the reporting repository. The number of usage items in a subgraph of the hierarchy reveals how many times users were interested in the categories and attributes represented in that subgraph.

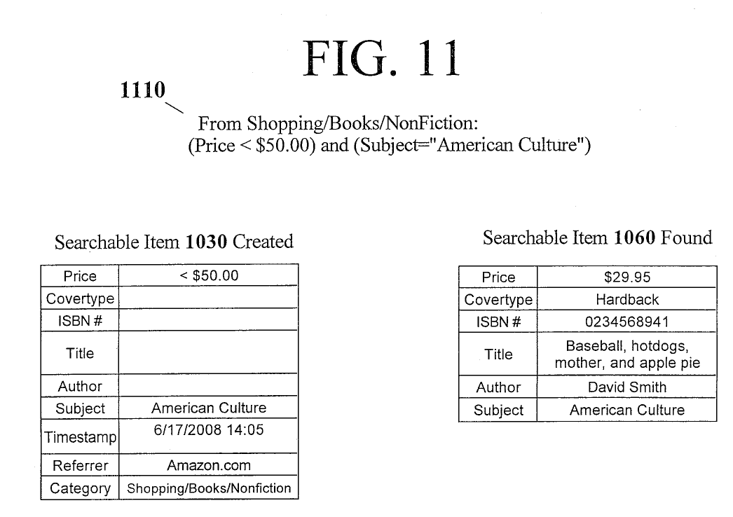

FIG. 11 shows an example query along with the contents of a searchable item in the content repository represented by a search result of the query and the corresponding usage item constructed from the query in the reporting repository. In query 1110, the attributes name/value pairs searched for are items of non-fiction books (implicit based on the context) about American Culture that cost less than $50.00. The searchable item 1060 has the attributes inherited from the category nodes shopping/books/nonfiction, and every searchable item in the nonfiction subgraph has that structure. The usage item 1030 in the reporting hierarchy, created from the usage event data, includes the same structure as the corresponding searchable item in the content hierarchy. A usage item in the reporting hierarchy has additional attributes inherited from the nodes of the reporting tree that are specific to usage event data, such as timestamp, referrer, and the identity and representation of the category node providing context for the search, and from which the click was issued. Also, although there is space for attribute values for all of the attributes in 1060, only those values specified in the query are filled in.

### Using the Data in the Reporting Repository

A customer interacts with the reporting data to see what users have been searching for in the customer's repository. Such interaction can, for example, provide insight into the demographics of the users interested in their repository, help to predict optimal levels of inventory, or help choose suppliers. For example, perhaps a customer is ordering a new line of clothing and wants to know which clothing colors are the most popular so as to know what to order. The customer can use the guided navigation feature to explore the “clothing” category and click the “color” attribute to find which clothing colors have had the most hits.

### Hardware Overview

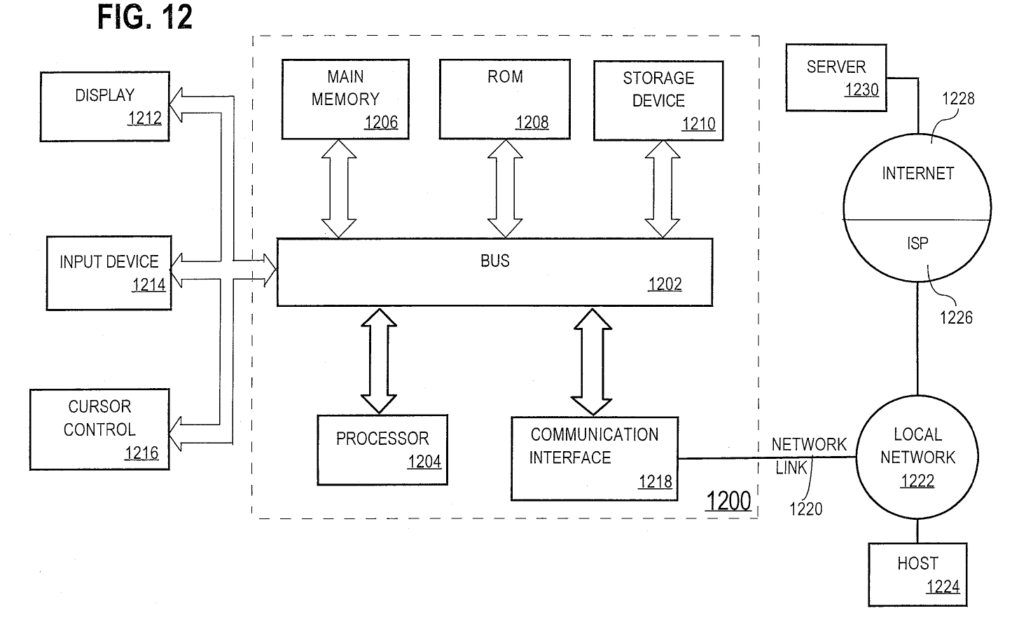

FIG. 12 is a block diagram that illustrates a computer system 1200 upon which an embodiment of the invention may be implemented. Computer system 1200 includes a bus 1202 or other communication mechanism for communicating information, and a processor 1204 coupled with bus 1202 for processing information. Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The invention is related to the use of computer system 1200 for implementing the techniques described herein. According to one embodiment of the invention, those techniques are performed by computer system 1200 in response to processor 1204 executing one or more sequences of one or more instructions contained in main memory 1206. Such instructions may be read into main memory 1206 from another machine-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1200, various machine-readable media are involved, for example, in providing instructions to processor 1204 for execution. Such a medium may take many forms, including but not limited to storage media and transmission media. Storage media includes both non-volatile media and volatile media. Non-volatile media includes, for example, optical or magnetic disks, such as storage device 1210. Volatile media includes dynamic memory, such as main memory 1206. Transmission media includes coaxial cables, copper wire and fiber optics, including the wires that comprise bus 1202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are exemplary forms of carrier waves transporting the information.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution. In this manner, computer system 1200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for reporting search engine usage information, comprising the steps of:
receiving, through an interface provided by a search engine, search criteria to find searchable items within a content repository;
in response to detecting an action that indicates user interest in searchable items that satisfy said search criteria, performing the steps of
creating a usage item that based on the searchable items in which the action indicates user interest;
adding the usage item to a reporting repository;
receiving, through said interface provided by said search engine, from users of the reporting repository, requests for usage data that indicates how users are using the content repository; and
responding to said requests based on usage items stored in the reporting repository.

2. The method of claim 1, wherein:
the content repository is represented by a first hierarchy of nodes; and
the reporting repository is represented by a second hierarchy of nodes that correspond to the first hierarchy of nodes.

3. The method of claim 2 wherein:
the search criteria indicates a first node of the first hierarchy of nodes; and
the step of adding the usage item to the reporting repository includes adding the usage item to a second node of the second plurality of nodes, wherein the second node corresponds to the first node.

4. The method of claim 1 wherein the usage item contains a timestamp that indicates a time associated said action.

5. The method of claim 3 wherein the usage item contains data indicating a region of a page associated with the first node.

6. The method of claim 1 wherein the usage item further comprises a referrer identifier.

7. The method of claim 1 wherein the usage item further comprises a set of attribute name/value pairs that correspond to at least a portion of the search criteria.

8. The method of claim 2 wherein categories represented by nodes in the first hierarchy of nodes are also represented by nodes in the second hierarchy of nodes.

9. The method of claim 1 wherein:
the content repository is organized in a hierarchy of categories; and
the step of detecting an action includes detecting that a user has navigated to a particular location in the hierarchy of categories.

10. The method of claim 1 wherein:
the method includes presenting a user with search results that are based on the search criteria; and
the step of detecting an action includes detecting that a user has selected a searchable item listed in the search results.

11. The method of claim 1 wherein the step of receiving requests for usage data includes receiving queries to execute against the report repository.

12. The method of claim 2 wherein the step of receiving requests for usage data includes receiving navigation input indicating navigation of a user through categories represented by the second hierarchy of nodes.

13. A method comprising:
collecting usage information from a search engine that is used to perform searches against searchable items in a first repository that is organized according to a first hierarchy of categories;
storing said usage information in a second repository that is organized in a second hierarchy that is based on the first hierarchy;
wherein the step of collecting includes generating a usage event record in response to a search of said first repository involving a first node of said first hierarchy;
wherein the step of storing said usage information includes
selecting a second node, within the second hierarchy, based on the location of the first node in the first hierarchy; and
storing the usage event record in association with said second node.

14. A computer-implemented method for displaying multidimensional usage information comprising the steps of:
storing multidimensional usage data in a reporting repository that is organized in a hierarchy of categories, wherein each category of the hierarchy of categories is associated with a set of one or more attributes;
wherein each category of the hierarchy of categories is associated with a set of usage items;
wherein each usage item of the set of usage items of a category indicates a detected demonstration of interest in searchable items that belong to the category;
displaying a view that includes a set of categories and a set of name/value pairs;
receiving from a user a request for multidimensional usage information;
wherein the request is in response to the user selecting from the view a category and one or more attribute name/value pairs;
in response to the request, generating a search query to find usage items within the reporting repository;
wherein the search query represents said category and said one or more attribute name/value pairs selected by the user;
retrieving usage items that satisfy said search query; and
displaying multidimensional usage information based on said usage items.

15. The method of claim 14 wherein:
the view includes a results area; and
the step of displaying includes displaying the multidimensional usage information in the results area based on said usage items.

16. The method of claim 14, wherein the multidimensional usage information is displayed as a graph.

17. The method of claim 14, wherein the multidimensional usage information is displayed as a table.

18. The method of claim 14, further comprising adding to the view subcategories of a category in response to a user selecting a name of the category displayed in the view.

19. The method of claim 14, wherein the multidimensional usage information includes the count of searchable items that satisfy said request.

20. A computer-readable storage medium storing one or more sequences of instructions which, when executed by one or more processors, causes the one or more processors to perform the method recited in claim 1.

21. A computer-readable storage medium storing one or more sequences of instructions which, when executed by one or more processors, causes the one or more processors to perform the method recited in claim 2.

22. A computer-readable storage medium storing one or more sequences of instructions which, when executed by one or more processors, causes the one or more processors to perform the method recited in claim 3.

23. A computer-readable storage medium storing one or more sequences of instructions which, when executed by one or more processors, causes the one or more processors to perform the method recited in claim 4.

24. A computer-readable storage medium storing one or more sequences of instructions which, when executed by one or more processors, causes the one or more processors to perform the method recited in claim 5.

25. A computer-readable storage medium storing one or more sequences of instructions which, when executed by one or more processors, causes the one or more processors to perform the method recited in claim 6.

26. A computer-readable storage medium storing one or more sequences of instructions which, when executed by one or more processors, causes the one or more processors to perform the method recited in claim 7.

27. A computer-readable storage medium storing one or more sequences of instructions which, when executed by one or more processors, causes the one or more processors to perform the method recited in claim 8.

28. A computer-readable storage medium storing one or more sequences of instructions which, when executed by one or more processors, causes the one or more processors to perform the method recited in claim 9.

29. A computer-readable storage medium storing one or more sequences of instructions which, when executed by one or more processors, causes the one or more processors to perform the method recited in claim 10.

30. A computer-readable storage medium storing one or more sequences of instructions which, when executed by one or more processors, causes the one or more processors to perform the method recited in claim 11.

31. A computer-readable storage medium storing one or more sequences of instructions which, when executed by one or more processors, causes the one or more processors to perform the method recited in claim 12.

32. A computer-readable storage medium storing one or more sequences of instructions which, when executed by one or more processors, causes the one or more processors to perform the method recited in claim 13.

33. A computer-readable storage medium storing one or more sequences of instructions which, when executed by one or more processors, causes the one or more processors to perform the method recited in claim 14.

34. A computer-readable storage medium storing one or more sequences of instructions which, when executed by one or more processors, causes the one or more processors to perform the method recited in claim 15.

35. A computer-readable storage medium storing one or more sequences of instructions which, when executed by one or more processors, causes the one or more processors to perform the method recited in claim 16.

36. A computer-readable storage medium storing one or more sequences of instructions which, when executed by one or more processors, causes the one or more processors to perform the method recited in claim 17.

37. A computer-readable storage medium storing one or more sequences of instructions which, when executed by one or more processors, causes the one or more processors to perform the method recited in claim 18.

38. A computer-readable storage medium storing one or more sequences of instructions which, when executed by one or more processors, causes the one or more processors to perform the method recited in claim 19.
